(19) United States
(12) Patent Application Publication
(10) Pub. No.: US 2006/0057375 A1
(43) Pub. Date: Mar. 16, 2006

(54) Drawn absorbent polymer fibers

(76) Inventors: Jorg Harren, Krefeld (DE); Jochen Houben, Kempen (DE); Rainer Teni, Moers (DE); Michael De Marco, Weinheim (DE)

Correspondence Address: SMITH MOORE LLP, P.O. BOX 21927, GREENSBORO, NC, 27420, US

(21) Appl. No.: 10/536,199

(22) PCT Filed: Nov. 28, 2003
(86) PCT No.: PCT/EP03/13396

§ 371 Date: Oct. 28, 2005

(30) Foreign Application Priority Data
Nov. 28, 2002 (DE) 102 55 418.8

(51) Int. Cl. B29C 51/00

(52) U.S. Cl. 428/364; 264/164

(57) ABSTRACT

The invention relates to a process for producing an aqueous phase- or water-absorbing polymer fiber from a composition comprising a polymer (A1) and water in an amount of at least 10 wt. %, based upon total weight of the polymer (A1), whereby at least two different regions of the polymer (A1) are moved away from each other by free pulling apart as a result of the effect of an external force and a device for producing these fibers, an absorbent polymer fiber as well as the use of these absorbent polymer fibers and of the device.

This application is a national stage application under 35 U.S.C. 371 of international application No. PCT/EP2003/013396 filed Nov. 28, 2003, which is based on German Application No. DE 102 55 418.8, filed Nov. 28, 2002, and claims priority thereto.

### FIELD OF THE INVENTION

The invention relates to a process for producing an aqueous phase- or water-absorbing polymer fiber, a device for producing these fibers, an absorbent polymer fiber as well as the use of these absorbent polymer fibers and of the device.

### BACKGROUND OF THE INVENTION

Besides particulate superabsorbers, superabsorbers in fiber form represent an advantageous three-dimensional form for hygiene applications because of their large surface area. Absorbent polymer fibers are in particular advantageous, since from these fibers—optionally in combination with non-absorbent fibers—can be produced laid materials, meshed materials or non-woven materials, in addition, absorbent polymer fibers have, compared to particulate superabsorbers, as a rule better absorption properties for protein-containing aqueous phases, for example blood, or liquids that are strongly stuck together.

It is not possible to produce in simple fashion fibers from absorbent polymers. As a rule, absorbent polymers are crosslinked, so that fiber production by means of spin nozzles presents significant problems.

For example, in the production of absorbent fibers using spin nozzles, uncrosslinked polyacrylic acids with softening comonomers are used. For other absorbent polymer fibers, a copolymer of maleic acid anhydride and isobutene forms the basis. In this way, the copolymers of maleic acid and isobutene are converted in uncrosslinked form by means of spin nozzles into a fiber form and then crosslinked by heating, whereby the crosslinker is added to the uncrosslinked polymer already before the conversion into the fiber form. Such a process is described, for example, in U.S. Pat. No. 5,151,465. The disadvantage in such a process lies, among others, in that frequently fibers with only low softness are pertained, which can only be used restrictedly for a use, for example in cable sheathings, because of the low adaptability of a fiber composite formed from the fibers to given surface profiles. The fibers, if used in the form of a fiber matrix sheet structure, cannot be used as a components of articles of clothing, since the low softness of the sheet structure reduces the flexibility of the article of clothing and thereby the wearer comfort.

The general object underlying the invention is to overcome the disadvantages arising from this state of the art.

### SUMMARY OF THE INVENTION

Furthermore, an object according to the invention lies in making available absorbent polymer fibers that are particularly suitable for use in hygiene articles.

The present invention also has the object of making available absorbent polymer fibers that are characterized by a particularly advantageous softness compared to previous absorbent polymer fibers.

The particular softness of the polymer fibers should, according to another object, also enable the fibers to be used in the form of a fiber matrix sheet structure, for example in cable sheathings, whereby the fiber matrix sheet structure, because of the particular softness of the fibers, is particularly well able to adapt itself to a given surface profile and can thereby be laid closely across the whole surface of surfaces with very different profiles. The fiber matrix sheet structure should also, because of its softness, be particularly suited for use in articles of clothing.

In addition, the present invention has the object of making available a process for producing absorbent polymer fibers, which reduces or overcomes the disadvantages of the production of absorbent polymer fibers by means of spin nozzles.

A further object according to the invention lies in making available a device, with which absorbent polymer fibers can be obtained without the disadvantages that are associated with the production of absorbent polymer fibers by spin nozzles.

In addition, an object of the present invention lies in making available fibers that—despite the reduction of the disadvantages associated with the production of absorbent polymer fibers by means of spin nozzles—have sufficiently good absorbent properties for use in hygiene articles.

Finally, an object according to the invention is to make available a hygiene article or the liquid-absorbing part of such a hygiene article, which reduces or overcomes the disadvantages associated with non-fibrous, but rather particulate, absorbent polymers, with as little as negative effect as possible on the wearer comfort and liquid absorption and retention performance.

### DETAILED DESCRIPTION OF THE INVENTION

The above objects are thus solved by a process for producing an aqueous phase- or water-absorbing polymer fiber from a composition comprising a polymer (A1) and water in a quantity within the range from about 10 to about 90 wt. %, preferably from about 20 to about 80 wt. % and even more preferably within a range from about 30 to about 70 wt. %, respectively based upon the total weight of the polymer (A1), whereby at least two different regions of the composition are moved away from each other by free pulling apart as a result of the effect of an external force.

As polymer (A1) can be used polymers that are less crosslinked than the polymer fiber, preferably crosslinked, preferably lightly crosslinked, and uncrosslinked polymers, preferably uncrosslinked polymers, can be used. These polymers (A1) are preferably based besides water upon:
(α1) from about 0.1 to 100 wt.%, preferably from about 20 to about 98.99 wt.% and particularly preferably from about 30 to about 98.95 wt. % of polymerized, ethylenically unsaturated, acidic groups-containing monomers or salts thereof, or polymerized, ethylenically unsaturated monomers comprising a protonated or a quaternary nitrogen, or mixtures thereof, wherein mixtures comprising at least ethylenically unsaturated, acidic groups-containing monomers, preferably acrylic acid, are particularly preferred,
(α2) 0 to about 70 wt. %, preferably from about 1 to about 60 wt. % and particularly preferably from about 1 to about 40 wt. % of polymerized, ethylenically unsaturated monomers which are co-polymerizable with (α1),
(α3) 0 to about 30 wt. %, preferably from about 0.01 to about 20 wt. % and particularly preferably from about 0.05 to about 15 wt. % and even more preferably from about 0.1 to about 10 wt. % of one or more cross-linkers,
(α4) 0 to about 30 wt. %, preferably from about I to about 20 wt. % and particularly preferably from about 5 to about 10 wt. % of water soluble polymers, as well as
(α5) 0 to about 20 wt. %, preferably from about 0.01 to about 7 wt. % and particularly preferably from about 0.05 to about 5 wt. % of one or more additives, wherein the sum of the weight parts (α1) to (α5) amounts to 100 wt. %.

The monoethylenically unsaturated, acid groups-containing monomers (α1) can be partially or fully, preferably partially neutralized. Preferably the monoethylenically unsaturated, acid group-containing monomers are neutralized within the range of from about 20 to about 80 mol %, particularly preferably within the range from about 30 to about 70 mol % and even more preferably within the range from about 40 to about 60 mol %. The neutralization of the monomers (α1) can occur before or also after the polymerization. Further, the neutralization can occur with alkali metal hydroxides, alkaline earth metal hydroxides, ammonia as well as carbonates and bicarbonates. In addition, every further base is conceivable which forms a water-soluble salt with the acid. A mixed neutralization with different bases is also conceivable. Neutralization with ammonia or with alkali metal hydroxides is preferred, particularly preferred with sodium hydroxide or with ammonia. Concerning the degree of neutralization, the number of free acid groups can be checked by reaction with further crosslinkers that react with the unneutralized acid groups of the polymer. The absorbency properties of the absorbent polymer fiber can be preferably controlled by means of the number of free acid groups and the amount of crosslinker used.

Furthermore in a polymer fiber or polymer the free acid groups may predominate, so that this absorbent polymer fiber has a pH value lying in the acid range. This acidic water-absorbing polymer fiber may be at least partially neutralised by a polymer or a polymer fiber or a mixture thereof with free basic groups, preferably amine groups that is basic compared to the acidic polymer. In this neutralization it is preferred that respectively at least one acidic polymer fiber is combined with a basic particle or basic polymer fiber or vice versa to form a mixture. It is particularly preferred to mix at least one acidic polymer fiber with a basic polymer or with a basic polymer fiber, preferably with a basic polymer. These polymer mixtures are termed “mixed-bed ion-exchange absorbent polymers” (MBIEA polymers) in the literature and are disclosed in, inter alia, WO 99/34843. The disclosure of WO 99/34843 is introduced here by way of reference. As a rule MBIEA polymers represent a composition that comprises on the one hand basic polymers that are able to exchange anions, and on the other hand contain a polymer that is acidic compared to the basic polymer and that is able to exchange cations. The basic polymer comprises basic groups and is typically obtained by the polymerization of monomers that carry basic groups or groups that can be converted into basic groups. These monomers are in particular those that comprise primary, secondary or tertiary amines or the corresponding phosphines or at least two of the aforementioned functional groups. This group of monomers includes in particular ethyleneamine, allylamine, diallylamine, 4-aminobutene, alkyloxycyclene, vinylformamide, 5-aminopentene, carbodiimide, formaldacin, melanin and the like, as well as their secondary or tertiary amine derivatives.

Preferred monoethylenically unsaturated, acidic group-containing monomers (α1) are acrylic acid, methacrylic acid, ethacrylic acid, α-chloroacrylic acid, α-cyanoacrylic acid, β-methylacrylic acid (crotonic acid), α-phenylacrylic acid, β-acryloxypropionic acid, sorbinic acid, α-chlorosorbinic acid, 2′-methylisocrotonic acid, cinnamic acid, p-chlorocinnamic acid, β-stearic acid, itaconic acid, citraconic acid, mesaconic acid, gluta-conic acid, aconitic acid, maleic acid, fumaric acid, tricarboxyethylene and maleic acid an-hydride, wherein acrylic acid and methacrylic acid are particularly and acrylic acid even more particularly preferred.

Besides these carboxylate group-containing monomers, further preferred monoethylenically unsaturated acidic groups-containing monomers (α1) are ethylenically unsaturated sulfonic acid monomers or ethylenically unsaturated phosphonic acid monomers.

Preferred ethylenically unsaturated sulfonic acid monomers are allylsulfonic acid or aliphatic or aromatic vinylsulfonic acids or acrylic or methacrylic sulfonic acids. Preferred aliphatic or aromatic vinylsulfonic acids are vinylsulfonic acid, 4-vinylbenzylsulfonic acid, vinyltoluenesulfonic acid and styrenesulfonic acid. Preferred acrylic or methacrylic sulfonic acids are sulfoethyl(meth)acrylate, sulfopropyl(meth)acrylate and 2-hydroxy-3-methacryloxypropylsulfonic acid. As (meth)acrylamidoalkylsulfonic acid, 2-acrylamido-2-methylpropanesulfonic acid is preferred.

Additionally preferred are ethylenically unsaturated phosphonic acid monomers, such as vinylphosphonic acid, allylphosphonic acid, vinylbenzylphosphonic acid, (meth)acrylamidoalkylphosphonic acids, acrylamidoalkyldiphosphonic acids, phosphono-methylated vinylamines and (meth)acrylphosphonic acid derivatives.

Preferred ethylenically unsaturated monomers (α1) containing a protonated nitrogen are preferably dialkylaminoethyl(meth)acrylates in the protonated form, for example dimethylaminoethyl(meth)acrylate hydrochloride or dimethylaminoethyl(meth)acrylate hydrosulfate, as well as dialkylaminoalkyl(meth)acrylamides in the protonated form, for example dimethylaminoethyl(meth)acrylamide hydrochloride, dimethylaminopropyl(meth)acrylamide hydrochloride, dimethylaminopropyl(meth)acrylamide hydrosulfate or dimethylaminoethyl(meth)acrylamide hydrosulfate.

Preferred ethylenically unsaturated monomers (α1) containing a quaternated nitrogen are dialkylammoniumalkyl(meth)acrylates in quaternated form, for example trimethylammonium-ethyl(meth)acrylate methosulfate or dimethylethylammoniumethyl(meth)acrylate-ethosulfate as well as (meth)acrylamidoalkyldialkylamine in quaternated form, for example (meth)acrylamidopropyltrimethylammonium chloride, trimethylammoniumethyl(meth)-acrylate chloride or (meth)acrylamidopropyltrimethylammonium sulfate.

It is preferred according to the present invention that the water-absorbing polymer (A1) comprises at least about 50 wt. %, preferably at least about 70 wt. % and more preferably at least about 90 wt. % carboxylate group-containing monomers, respectively based upon the total weight of the components (α1) to (α5). It is particularly preferred according to the invention that the polymer comprises at least about 50 wt. %, preferably at least about 70 wt. % , respectively based upon the total weight of the components (α1) to (α5), acrylic acid, which is neutralised preferably to at least about 20 mol %, particularly preferably to at least 50 mol %, based on the acid groups comprised in the polymer (A1). In a particular embodiment of the process according to the invention, as polymer (A1) is used a polymer which is based to at least about 98 wt. %, preferably to 100 wt. %, on polymerized acrylic acid, which is neutralized to at least about 20 mol %, preferably to at least about 50 mol %.

Preferred monoethylenically unsaturated monomers (α2) which are copolymerisable with (α1) are acrylamides and (meth)acrylamides. Possible (meth)acrylamides besides acrylamide and methacrylamide are alkyl-substituted (meth)acrylamides or aminoalkyl-substituted derivatives of (meth)acrylamide such as N-methylol(meth)acrylamide, N,N-dimethylamino(meth)acrylamide, dimethyl(meth)acrylamide or diethyl(meth)acrylamide. Possible vinylamides are for example N-vinylamides, N-vinylformamides, N-vinylacetamides, N-vinyl-N-methylacetamides, N-vinyl-N-methylformamides, vinylpyrrolidone. Among these monomers acrylamide is particularly preferred.

Further preferred monoethylenically unsaturated monomers (α2) which are copolymerisable with (α1) are water-dispersible monomers. Preferred water-dispersible monomers are acrylic acid esters and methacrylic acid esters, such as methyl(meth)acrylate, ethyl(meth)acrylate, propyl(meth)acrylate or butyl(meth)acrylate, as well as vinylacetate, styrene and isobutylene.

Preferred cross-linkers (α3) according to the invention are compounds which have at least two ethylenically unsaturated groups in one molecule (cross-linker class I), compounds which have at least two functional groups which can react with functional groups of the monomers (α1) or (α2) in a condensation reaction (=condensation cross-linkers), in an addition reaction or a ring-opening reaction (cross-linker class II), compounds which have at least one ethylenically unsaturated group and at least one functional group which can react with functional groups of the monomers (α1) or (α2) in a condensation reaction, an addition reaction or a ring-opening reaction (cross-linker class III), or polyvalent metal cations (cross-linker class IV). Thus with the compounds of cross-linker class I a cross-linking of the polymer is achieved by radical polymerization of the ethylenically unsaturated groups of the cross-linker molecules with the monoethylenically unsaturated monomers (α1) or (α2), while with the compounds of cross-linker class II and the polyvalent metal cations of cross-linker class IV a cross-linking of the polymer is achieved respectively via condensation reaction of the functional groups (cross-linker class II) or via electrostatic interaction of the polyvalent metal cation (cross-linker class IV) with the functional groups of the monomer (α1) or (α2). With compounds of cross-linker class III a cross-linking of the polymers is achieved correspondingly by radical polymerization of the ethylenically unsaturated groups or also by condensation reaction between the functional groups of the cross-linkers and the functional groups of the monomers (α1) or (α2).

Preferred compounds of cross-linker class I are poly(meth)acrylic acid esters, which have been obtained for example by conversion of a polyol, such as for example ethylene glycol, propylene glycol, trimethylolpropane, 1,6-hexanediol, glycerine, pentaerythritol, polyethyleneglycol or polypropyleneglycol, of an aminoalcohol, a polyalkylenepolyamine, such as for example diethylenetriamine or triethylenetetraamine, or of an alkoxylated polyol with acrylic acid or methacrylic acid. Further preferred compounds of cross-linker class I are polyvinyl compounds, poly(meth)allyl compounds, (meth)acrylic acid esters of a monovinyl compound or (meth)acrylic acid esters of a mono(meth)allyl compound, preferably of the mono(meth)allyl compounds of a polyol or of an aminoalcohol. In this context reference is made to DE 195 43 366 and DE 195 43 368.

As examples of compounds of cross-linker class I are named alkenyldi(meth)acrylates, for example ethyleneglycoldi(meth)acrylate, 1,3-propyleneglycoldi(meth)acrylate, 1,4-butyleneglycoldi(meth)acrylate, 1,3-butyleneglycoldi(meth)acrylate, 1,6-hexanedioldi(meth)acrylate, 1,10-decanedioldi(meth)acrylate, 1,1 2-dodecanedioldi(meth)acrylate, 1,18-octadecanedioldi(meth)acrylate, cyclopentanedioldi(meth)acrylate, neopentylglycoldi(meth)acrylate, methylenedi(meth)acrylate or pentaerythritoldi(meth)acrylate, alkenyldi(meth)acrylamides, for example N-methyldi(meth)acrylamide, N,N′-3-methylbutylidenebis(meth)acrylamide, N,N′-(1,2-dihydroxyethylene)bis(meth)acrylamide, N,N′-hexamethylenebis(meth)acrylamide or N,N′-methylenebis(meth)acrylamide, polyalkoxydi(meth)acrylates, for example diethyleneglycoldi(meth)acrylate, triethyleneglycoldi(meth)acrylate, tetraethyleneglycoldi(meth)acrylate, dipropyleneglycoldi(meth)acrylate, tripropyleneglycoldi(meth)acrylate or tetrapropyleneglycoldi(meth)acrylate, bisphenol-A-di(meth)acrylate, ethoxylated bisphenol-A-di(meth)acrylate, benzylidenedi(meth)acrylate, 1,3-di(meth)acryloyloxypropanol-2, hydroquinonedi(meth)acrylate, di(meth)acrylate esters of trimethylolpropane which is preferably alkoxylated with 1 to 30 mol alkylene oxide per hydroxyl group and preferably ethoxylated, thioethyleneglycoldi(meth)acrylate, thiopropyleneglycoldi(meth)acrylate, thiopolyethyleneglycoldi(meth)acrylate, thiopolypropyleneglycoldi(meth)acrylate, divinyl ethers, for example 1,4-butanedioldivinyl ether, divinyl esters, for example divinyl adipate, alkanedienes, for example butadiene or 1,6-hexadiene, divinylbenzene, di(meth)allyl compounds, for example di(meth)allyl phthalate or di(meth)allyl succinate, homo- and co-polymers of di(meth)allyldimethylammonium chloride and homo- and co-polymers of diethyl(meth)allylaminomethyl(meth)acrylateammonium chloride, vinyl(meth)acrylic compounds, for example vinyl(meth)acrylate, (meth)allyl(meth)acrylic compounds, for example (meth)allyl(meth)acrylate, (meth)allyl(meth)acrylate ethoxylated with 1 to 30 mol ethylene oxide per hydroxyl group, di(meth)allyl esters of polycarboxylic acids, for example di(meth)allyl maleate, di(meth)allyl fumarate, di(meth)allyl succinate or di(meth)allyl terephthalate, compounds with 3 or more ethylenically unsaturated, radically polymerisable groups such as for example glycerine tri(meth)acrylate, (meth)acrylate esters of glycerine preferably ethoxylated with 1 to 30 mol ethylene oxide per hydroxyl group, trimethylolpropanetri(meth)acrylate, tri(meth)acrylate esters of trimethylolpropane which is preferably alkoxylated with 1 to 30 mol alkylene oxide per hydroxide group and preferably ethoxylated, trimethacrylamide, (meth)allylidenedi(meth)acrylate, 3-allyloxy-1,2-propanedioldi(meth)acrylate, tri(meth)allylcyanurate, tri(meth)allylisocyanurate, pentaerythritoltetra(meth)acrylate, pentaerythritoltri(meth)acrylate, (meth)acrylic acid esters of pentaerythritol which is preferably ethoxylated with 1 to 30 mol ethylene oxide per hydroxyl group, tris(2-hydroxyethyl)isocyanurate-tri(meth)acrylate, trivinyltrimellitate, tri(meth)allylamine, di(meth)allylalkylamines, for example di(meth)allylmethylamine, tri(meth)allylphosphate, tetra(meth)allylethylenediamine, poly(meth)allyl ester, tetra(meth)allyloxyethane or tetra(meth)allylammonium halides. According to the invention, in crosslinker class I, vinylisocyanate, trivinyltrimellitate or tri(meth)allylisocyanurate are preferred, whereby trivinyltrimellitate is particularly preferred.

As compound of cross-linker class II are preferred compounds that have at least two functional groups that can react in a condensation reaction (=condensation cross-linkers), in an addition reaction or in a ring opening reaction with the functional groups of the monomers (α1) or (α2), preferably with acidic groups of the monomers (α1). These functional groups of the compounds of cross-linker class II are alcohol, amine, aldehyde, glycidic, isocyanate, carbonate or epichloro functions.

As examples of compounds of cross-linker class II are mentioned polyols, for example ethylene glycol, polyethylene glycols such as diethylene glycol, triethylene glycol and tetraethylene glycol, propylene glycol, polypropylene glycols such as dipropylene glycol, tripropylene glycol or tetrapropylene glycol, 1,3-butanediol, 1,4-butanediol, 1,5-pentanediol, 2,4-pentanediol, 1,6-hexanediol, 2,5-hexanediol, glycerine, polyglycerine, trimethylolpropane, polyoxypropylene, oxyethylene-oxypropylene block copolymers, sorbitan-fatty acid esters, polyoxyethylene sorbitan-fatty acid esters, pentaerythritol, polyvinylalcohol and sorbitol, aminoalcohols, for example ethanolamine, diethanolamine, triethanolamine or propanolamine, polyamine compounds, for example ethylenediamine, diethylenetriamine, triethylenetetraamine, tetraethylenepentaamine or pentaethylenehexaamine, polyglycidyl ether compounds such as ethyleneglycoldiglycidyl ether, polyethyleneglycoldiglycidyl ether, glycerinediglycidyl ether, glycerinepolyglycidyl ether, pentaerithritolpolyglycidyl ether, propyleneglycoldiglycidyl ether, polypropyleneglycoldiglycidyl ether, neopentylglycoldiglycidyl ether, hexanediolglycidyl ether, trimethylolpropanepolyglycidyl ether, sorbitolpolyglycidyl ether, phthalic acid diglycidyl ester, adipinic acid diglycidyl ether, 1,4-phenylenebis(2-oxazoline), glycidol, polyisocyanates, preferably diisocyanates such as 2,4-toluenediioscyanate and hexamethylenediisocyanate, polyaziridine compounds such as 2,2-bishydroxymethylbutanol-tris[3-(1-aziridinyl)propionate], 1,6-hexamethylenediethylene urea and diphenylmethane-bis-4,4′-N,N′-diethylene urea, halogen epoxides for example epichloro- and epibromohydrin and α-methylepichlorohydrin, alkylene carbonates such as 1,3-dioxolane-2-one (ethylene carbonate), 4-methyl-1,3-dioxolane-2-one (propylene carbonate), 4,5-dimethyl-1,3-dioxolane-2-one, 4,4-dimethyl-1,3-dioxolane-2-one, 4-ethyl-1,3-dioxolane-2-one, 4-hydroxymethyl-1,3-dioxolane-2-one, 1,3-dioxane-2-one, 4-methyl-1,3-dioxane-2-one, 4,6-dimethyl-1,3-dioxane-2-one, 1,3-dioxolane-2-one, poly-1,3-dioxolane-2-on, polyquaternary amines such as condensation products from dimethylamines and epichlorohydrin. Further preferred compounds of the cross-linker class II are in addition polyoxazolines such as 1,2-ethylenebisoxazoline, cross-linkers with silane groups such as γ-glycidooxypropyltrimethoxysilane and γ-aminopropyltrimethoxysilane, oxazolidinones such as 2-oxazolidinone, bis- and poly-2-oxazolidinone and diglycolsilicates.

Preferred compounds of class III are hydroxyl or amino group-comprising esters of (meth)acrylic acid, such as for example 2-hydroxyethyl(meth)acrylate, as well as hydroxyl or amino group-containing (meth)acrylamides, or mono(meth)allylic compounds of diols.

The polyvalent metal cations of cross-linker class IV are derived preferably from singly or multiply charged cations, the singly charged in particular from alkali metals such as potassium, sodium, lithium, wherein lithium is preferred. Preferred doubly charged cations are derived from zinc, beryllium, alkaline earth metals such as magnesium, calcium, strontium, wherein magnesium is preferred. Further cations applicable according to the invention, with higher charge, are cations from aluminium, iron, chromium, manganese, titanium, zirconium and other transition metals as well as double salts of such cations or mixtures of the named salts. The use of aluminium salts and alums and various hydrates thereof such as e.g. AlCl₃.6 H₂O, NaAl(SO₄)₂.12 H2O, KAl(SO₄)₂.12 H2O or H₂O are preferred. The use of Al₂(SO₄)₃ and its hydrates as cross-linkers of the crosslinker class IV is particularly preferred.

Preferred crosslinked or lightly crosslinked polymers are polymers which are crosslinked, preferably lightly crosslinked, respectively by crosslinkers of the following crosslinker classes or by crosslinkers of the following combinations of cross-linker classes: I, II, III, IV, I II, I III, I IV, I II III, I II IV, I III IV, II III IV, II IV or III IV. The above combinations of cross-linker classes represent respectively a preferred embodiment of cross-linkers of a of a crosslinked or lightly crosslinked polymer (A1).

In an embodiment according to the invention of the polymer (A1), the concentration of at least one crosslinker of crosslinker class II predominates in comparison to the concentrations of at least one crosslinker of another above-named crosslinker class. In a further embodiment according to the invention of the polymer (A1), the concentration of at least one crosslinker of crosslinker class III predominates in comparison to the concentrations of at least one crosslinker of another above-cited crosslinker class. In another embodiment according to the invention of the polymer (A1), the concentration of a mixture of at least one crosslinker of crosslinker class II and at least one crosslinker of crosslinker class III predominates in comparison to the concentrations of at least one crosslinker of another above-named crosslinker class.

Further embodiments of the crosslinked or lightly crosslinked polymers (A1) used in the process according to the invention are polymers which are crosslinked, preferably lightly crosslinked, by any of the above named crosslinkers of crosslinker class I. Among these, water-soluble crosslinkers are preferred. In this context, N,N′-methylenebisacrylamide, polyethylene glycol di(meth)acrylates, triallylmethylammonium chloride, tetraallylammonium chloride as well as allylnonaethylene glycol acrylate made with 9 mol ethylene oxide per mol acrylic acid are particularly preferred.

As water-soluble polymers (α4), water soluble polymerizates such as those comprising partially or fully saponified polyvinyl alcohol, polyvinylpyrrolidone, starches or starch derivatives, polyglycols or polyacrylic acids can be present, preferably be polymerized into the polymers (A1). The molecular weight of these polymers is not critical, as long as they are water-soluble. Preferred water-soluble polymers are starches or starch derivatives or polyvinyl alcohol. The water-soluble polymers, preferably synthetic such as polyvinyl alcohol, can also serve as graft basis for the monomers to be polymerized. As additives (α5), suspension agents, odour binders, surface-active agents, or antioxidants are preferably used.

The polymer (A1) can be produced from the above-named monomers and cross-linkers by various polymerization means. For example, in this context can be named bulk polymerization that occurs preferably in kneading reactors such as extruders or by band polymerization, solution polymerization, spray polymerization, inverse emulsion polymerization and inverse suspension polymerization. Solution polymerization is preferably carried out in water as solvent. The solution polymerization can occur continuously or discontinuously, as can the other above-mentioned polymerization types. The solution polymerization preferably occurs as continuously running band polymerization. From the prior art a broad spectrum of variation possibilities can be learnt with respect to reaction proportions such as temperatures, type and quantity of the initiators as well as of the reaction solution. Typical processes are described in the following patent specifications: U.S. Pat. No. 4,286,082, DE 27 06 135, U.S. Pat. No. 4,076,663, DE 35 03 458, DE 40 20 780, DE 42 44 548, DE 43 23 001, DE 43 33 056, DE 44 18 818.

Polymerization initiators may be dissolved or dispersed in a solution of monomers according to the invention. As initiators there may be used all compounds known to the person skilled in the art that decompose to form radicals. Such compounds include in particular peroxides, hydroperoxides, hydrogen peroxide, persulfates, azo compounds as well as the so-called redox catalysts. It is preferred to use water-soluble catalysts. In some cases it is advantageous to use mixtures of various polymerization initiators. Among such mixtures, those consisting of hydrogen peroxide and sodium or potassium peroxodisulfate are preferred, which may be used in any desired quantitative ratio. Suitable organic peroxides are preferably acetylacetone peroxide, methyl ethyl ketone peroxide, tert.-butyl hydroperoxide, cumene hydroperoxide, tert.-amyl perpivate, tert.-butyl perpivate, tert.-butyl perneohexonate, tert.-butyl isobutyrate, tert.-butyl per-2-ethylhexenoate, tert.-butyl perisononanoate, tert.-butyl permaleate, tert.-butyl perbenzoate, tert.-butyl-3,5,5-trimethylhexanoate and amyl pemeodecanoate. The following are furthermore preferred as polymerization initiators: azo compounds such as 2,2′-azobis-(2-amidinopropane)dihydrochloride, azo-bis-amidinopropane dihydrochloride, 2,2′-azobis-(N,N-dimethylene)isobutyramidine dihydrochloride, 2-(carbamoylazo)isobutyronitrile and 4,4′-azobis-(4-cyano-valeric acid). The aforementioned compounds are used in conventional amounts, preferably in a range from about 0.01 to about 5 mol %, more preferably about 0.1 to about 2 mol %, in each case based upon the amount of the monomers to be polymerized.

The redox catalysts contain as oxidic component at least one of the per compounds listed above, and contain as reducing component preferably ascorbic acid, glucose, sorbose, mannose, ammonium or alkali metal hydrogen sulfite, sulfate, thiosulfate, hyposulfite or sulfide, metal salts such as iron II ions or silver ions or sodium hydroxymethyl sulfoxylate. Preferably ascorbic acid or sodium pyrosulfite is used as reducing component of the redox catalyst. About 1·10⁻⁵ to about 1 mol % of the reducing component of the redox catalyst and about 1·10⁻⁵ to about 5 mol % of the oxidizing component of the redox catalyst are used, in each case referred to the amount of monomers used in the polymerization. Instead of the oxidizing component of the redox catalyst, or as a complement thereto, one or more, preferably water-soluble azo compounds may be used.

A redox system comprising hydrogen peroxide, sodium peroxodisulfate and ascorbic acid is preferably used according to the invention. In general, according to the invention azo compounds are preferred as initiators, azo-bis-amidinopropane dihydrochloride being particularly preferred. As a rule the polymerization is initiated with the initiators in a temperature range from about 30° to about 90° C.

After the production of the polymers (A1), the polymer solutions are optionally concentrated or diluted with water, in order to obtain a water content of the composition in the previously mentioned range of amounts.

Preferably, the polymers (A1) used in the process according to the invention have at least one, preferably all of the following properties:
a. a polydispersity D determined according to the GPC method A.AN-LC.004 of at most about 8, preferably at most about 6 and particularly preferably at most about 4 and even more preferably at most about 3,
b. a viscosity according to Brookfield (DIN 53019) in a 30 wt. % polymer-comprising aqueous solution at 23° C. within a range from about 100 to about 500,000 mPa.s, preferably from about 1,000 to about 100,000 mPa.s, and particularly preferably from about 10,000 to about 70,000 mPa.s,
c. a viscosity according to Brookfield (DIN 53019) in a 30 wt. % polymer-comprising aqueous solution at 60° C. within a range from about 100 to about 100,000 mPa.s, preferably from about 500 to about 50,000 mPa.s, and particularly preferably from about 1,000 to about 10,000 mPa.s
d. a weight average of the molecular weight (M_{W}) determined according to the GPC method A.AN-LC.004 within the range from about 50,000 to about 2,000,000 g/mol, preferably from about 100,000 to about 1,000,000 g/mol and particularly preferably from about 200,000 to about 500,000 g/mol.

Preferably, polymers (A1) are used in the process according to the present invention which are characterized by the following properties or combinations of properties: a, b, c, d, ab, ac, ad, bc, bd, cd, abc, abd, acd, bcd, bce, abcd.

Preferably, the composition comprising polymers (A1) used in the process according to the invention has a viscosity according to Brookfield (DIN 53019) at 23° C. within a range from about 100 to about 500,000 mPa.s, preferably from about 1,000 to about 100,000 mPa.s, and particularly preferably from about 10,000 to about 70,000 mPa.s and at 60° C. within a range from about 100 to about 100,000 mPa.s, preferably from about 500 to about 50,000 mPa.s, and particularly preferably from about 1,000 to about 10,000 mPa.s.

It is furthermore preferred that the composition has a residual monomer content determined according to the GPC method A.AN-LC.004 within a range from about 10 to about 10,000 ppm acrylic acid, preferably from about 500 to about 5,000 ppm acrylic acid and particularly preferably from about 1,000 to about 2,500 ppm acrylic acid.

In a preferred embodiment of the process according to the invention, as polymer (A1) are employed uncrosslinked polymers. In another preferred embodiment of the process according to the invention, as polymer (A1) are used crosslinked, preferably lightly crosslinked polymers. The degree of crosslinking is preferably limited, such that the polymers (A1) in the process according to the invention can still be formed into a polymer fiber.

It is further preferred that the polymer (A1) is post-crosslinked. This post-crosslinking of the polymer preferably occurs during the pulling apart of the polymer (A1) or after this polymer has been pulled apart to form a polymer fiber. The crosslinking during or after the pulling apart is enabled in that the polymer (A1) already comprises crosslinkers of crosslinker classes II and IV, these crosslinkers, however, to at least about 50 wt. % and particularly preferably at least about 80 wt. %, based on the total weight of these crosslinkers, have not yet reacted with the other components of the polymer (A1) and thus have not yet crosslinked the polymer and in that during or after the pulling apart the conditions are altered in such a way that the crosslinkers comprised in the polymer (A1) crosslink the polymer.

Particularly preferred as post-crosslinker are diethylene glycol, triethylene glycol, polyethylene glycol, glycerol, polyglycerol, propylene glycol, diethanolamine, triethanolamine, polyoxypropylene, oxyethylene/oxypropylene block copolymers, sorbitan fatty acid esters, polyoxyethylenesorbitan fatty acid esters, trimethylolpropane, pentaerythritol, polyvinyl alcohol, sorbitol, 1,3-dioxolan-2-one (ethylene carbonate), 4-methyl-1,3-dioxolan-2-one (propylene carbonate), 4,5-dimethyl-1,3-dioxolan-2-one, 4,4-dimethyl-1,3-dioxolan-2-one, 4-ethyl-1,3 -dioxolan-2-one, 4-hydroxymethyl-1,3-dioxolan-2-one, 1,3-dioxan-2-one, 4-methyl-1,3-dioxan-2-one, 4,6-dimethyl-1,3-dioxan-2-one, 1,3-dioxolan-2-one, poly-1,3-dioxolan-2-one or mixtures of at least two thereof, whereby alcohols with 2 to 10 carbon atoms and at least 2 OH groups are particularly preferred and 1,4-butanediol, 1,3-propanediol or pentaerythritol or mixtures thereof are even more preferred.

It is furthermore preferred that the polymers (A1) comprise the crosslinkers of crosslinker classes II or IV or mixtures thereof, preferably the post-crosslinkers mentioned in the above paragraph, in a quantity within a range from 0.001 to 20 wt. %, particularly preferably within a range from 0.01 to 15 wt. % and even more preferably within a range from 0.1 to 10 wt. %, respectively based upon the total weight of the polymer (A1).

In a further embodiment of the absorbent polymer fiber according to the invention it is preferred that this is again converted into a post-crosslinked absorbent polymer fiber by bringing into contact the absorbent polymer fiber with crosslinkers of crosslinker classes II or IV or mixtures thereof, preferably the post-crosslinkers mentioned in the above paragraph, in a quantity within a range from about 0.001 to about 20 wt. %, particularly preferably within a range from about 0.01 to about 15 wt. % and even more preferably within a range from about 0.1 to about 10 wt. %, respectively based on the weight of the absorbent polymer fiber without these crosslinkers.

The production of polymers (A1) of this type, comprising a crosslinker of crosslinker classes II or IV, which are, however, not yet crosslinked by the crosslinkers, preferably occurs by incorporating the crosslinkers into the polymer (A1) comprising water in the above-mentioned amount, under conditions under which a crosslinking does not yet take place. The incorporation preferably occurs by kneading of the polymer solution in the presence of the post-crosslinker, preferably in an extruder, or by stirring the post-crosslinker into the polymer solution. The post-crosslinker can also be used in a liquid phase, preferably in water, in dissolved or dispersed form. In order to achieve an orderly post-crosslinking of the polymer fiber, it is preferred according to the invention that the post-crosslinking is caused by irradiation. The crosslinking by irradiation preferably occurs after the formation of the extended structure has started, preferably after the polymer fiber is present in its desired length. As irradiation forms are considered all processes known to the skilled person and suitable for crosslinking of the polymer fiber. Hereunder fall preferably heat irradiation, irradiation with visible light, irradiation with ultraviolet light, irradiation with ex-rays, irradiation with radioactive radiation as well as alpha-, gamma radiation, IR-irradiation and sound irradiation, whereby thermal treatment is particularly preferred. The thermal treatment preferably occurs within a temperature range from about 40 to about 250° C., preferably from about 80 to about 220° C. and particularly preferably from about 100 to about 210° C.

In a further embodiment of the process according to the invention, the polymer fiber post-crosslinked by the above-described method is additionally treated in the area of the surface of the polymer fiber. As post-treatment are preferred post-crosslinking in the area of the surface as well as the bringing into contact of the surface with a coating agent and the subsequent effect of energy or a combination of both.

The additional post-crosslinking of the surface leads to the formation of a core-shell structure. This post-crosslinking in the surface area can, as in the above-described post-crosslinking of the polymers (A1), occur thermally, photochemically or chemically. As post-crosslinkers for the chemical post-crosslinking are preferred compounds that were mentioned as post-crosslinkers for the crosslinking of the polymers (A1). Particularly preferred as post-crosslinker for the post-crosslinking of the surface portion of the polymer fibers is ethylene carbonate. The post-crosslinking preferably occurs by bringing into contact the surface of the polymer fiber with the post-crosslinking agent, preferably with a fluid phase comprising the post-crosslinking agent and by then heating the polymer fiber to a temperature within a range from about 30 to about 300° C.

In a further embodiment of the absorbent polymer fiber according to the invention it is preferred that this is converted again into a post-crosslinked absorbent polymer fiber by bringing into contact this absorbent polymer fiber with crosslinkers of crosslinker classes II or IV or mixtures thereof, preferably the post-crosslinkers mentioned in the above paragraph, in a quantity within a range from about 0.001 to about 20 wt. %, particularly preferably within a range from about 0.01 to about 15 wt. % and even more preferably within a range from about 0.1 to about 10 wt. %, respectively based upon the weight of the absorbent polymer fiber without these crosslinkers.

In another embodiment of the process according to the invention, the polymer fiber, preferably the polymer fiber post-crosslinked in the surface region, is brought into contact with a coating agent. The coating agent preferably has an organic and an inorganic component and is preferably present as coating agent particles, whereby it is preferred that the particles are smaller in diameter than the absorbent polymer fiber according to the invention.

It is furthermore preferred in the process according to the invention that the inorganic component is based upon a silicon compound, whereby all silicon oxygen compounds known to the skilled person, for example silicic acids and kaolins are preferred, among which silicic acids are particularly preferred.

It is furthermore preferred that the absorbent polymer fiber is brought into contact with the inorganic coating agent within a range from about 0.001 to about 40, preferably from about 0.01 to about 20 and particularly preferably from about 0.05 to about 5 wt. %, based upon the absorbent polymer fiber.

In the process according to the invention, it is preferred that by a free pulling apart of at least two different regions of the polymer (A1) is meant a pulling apart which dos not occur in a housing which is not form-locked with the thus arising elongated structure, in particular with the fiber according to the invention, particularly preferably not in a spin nozzle forming the fiber.

It is additionally preferred that in the process according to the invention the external force which acts upon at least two different regions of the polymer (A1) is selected so that this force forms the polymer into an elongated structure. In this context is advantageous that the force is selected so that on the one hand an elongated structure is formed from the polymer and on the other hand the formation of the elongated structure does not occur so quickly that the elongated structure splits into two parts. Additionally, in the process according to the invention, the speed with which the at least two different regions of the polymer (A1) are moved away from each other can have an influence on the formation of the elongated structure. As a result, the speed should likewise be selected so that in the formation of the elongated structure, this structure is not split into two parts. Rather, both the external force and the speed should be selected so that from the polymer (A1) an elongated structure is formed which is pulled increasingly further to a fiber. Furthermore, the viscosity of the polymer can have an influence on the form of the elongated structure. Thus it is preferred in the process according to the invention that the external force is at least about 0.1 N, preferably at least about 0.5 N and particularly at least about 1 N.

It is additionally preferred in the process according to the invention that the at least two regions are pulled away from each other with a speed of at least about 1 cm/sec, preferably at least about 10 cm/sec and particularly preferably at least about 100 to at most about 10,000 cm/sec.

The process according to the invention can be carried out by means of any device known to the skilled person which is capable of freely pulling away from each other at least two different regions of a polymer (A1) as a result of the effect of an external force, whereby the free pulling away from each other is preferably defined as described in connection with the process according to the invention.

The process according to the invention is preferably carried out using a device comprising:
β1) a polymer feed,
β2) at least two movable surfaces,
β3) a fiber-accepting device, and
β4) a fiber formation area,
   whereby the movable surfaces are arranged moving away from the polymer feed and with an increasing distance to each other from the polymer feed, forming the fiber formation area, and the fiber-accepting device is arranged at least partially in or outside the fiber formation area. This device is likewise a subject matter of the present invention.

The polymer feed is formed and arranged so that it can generate continuously endless polymer portions or discontinuously individual polymer portions from the fed polymer (A1), in which at least two regions are pulled away from each other by the effect of an external force. This occurs preferably in that the polymer feed comprises a conveying device, for example a conveying screw, and a portioning device such as a nozzle or hole plate, optionally with a separating device for generating individual polymer portions. The polymer feed generates polymer portions of a certain size. The size of the polymer portion depends upon with which distance the portions of the movable surfaces are arranged in the region of the polymer feed. It is preferred that the size of the polymer portions and the distance of the movable surface is selected so that the distance of the movable surfaces is as big as or smaller than the diameter of the portion. This has the advantage that when the portion meets the at least two movable surfaces, it can adhere in at least two regions of the portion on these surfaces.

The at least two movable surfaces are formed and arranged in such a way that on the one hand the polymer portion fed via the polymer feed to the surfaces initially adheres to the surfaces and the absorbent polymer fiber forming in the course of the further movement of the surfaces can be substantially separated from this fiber without destruction of the fiber. In this context, smooth surfaces are preferred, for example made from metal or plastic. Particularly preferred are surfaces coated with a hydrophobic polymer, preferably silicone. In a particularly preferred embodiment of the process according to the invention, a silicone paper is used as surface, as for example obtainable from the company B. Laufenberg GmbH, Krefeld under the reference “Transferpapier NSA 1350 (56 B3)” in the size 40 cm×250 m.

It is further preferred according to the invention that the movable surfaces are belts, which are preferably arranged as roll belts. In this context it is preferred that each of these roll belts comprises at the ends respectively start and end rolls. The start rolls located near the polymer feed are preferably arranged substantially parallel to each other, so that a gap is formed which is capable of taking up the polymer portion fed from the polymer feed. The end rolls of the roll belts are likewise preferably arranged substantially parallel to each other, whereby the distance forming between the end rolls is larger than the gap which forms between both start rolls in the area of the feed device. Both surfaces of the roll belts, the gap in the area of the polymer feed as well as the distance between the end rolls, forms the fiber formation area.

It is further preferred that the device according to the invention comprises an irradiation device for initiating the crosslinking reaction in the formation of the absorbent polymer fiber. The irradiation device is preferably arranged in such a way that the crosslinking reaction can be initiated during the formation of the absorbent polymer fiber in the fiber formation area or afterwards, preferably afterwards.

According to a further preferred embodiment of the device according to the invention, this device comprises a fiber-accepting device in the form of a movable accepting surface, which is formed and arranged in such a way that the absorbent polymer fibers being generated in the fiber formation area can be taken up in such a way that they are separated from the movable surfaces. This is preferably achieved in that the movable accepting surface effects a movement which initially reaches into a part of the fiber formation area and then, after take up of the absorbent polymer fibers, leads out of the fiber formation area. It is furthermore preferred in the device according to the invention that adjacent to the accepting surface preferably a take up device comprising an edge is arranged which is formed and arranged in such a way that it can remove and optionally collect the absorbent polymer fibers located on the accepting surface from this accepting surface.

According to another preferred embodiment of the device according to the invention, this device has as fiber-accepting device a suction device which is formed and arranged in such a way that the absorbent polymer fibers forming in the fiber formation area are separated and removed from the movable surfaces substantially destruction-free. To this end, the suction device generates a suitable reduced pressure.

It is further preferred that the process according to the invention for production of an absorbent polymer fiber occurs by means of the above-described device according to the invention.

The invention further relates to an absorbent polymer fiber that is obtainable according to one of the above described processes.

It is further preferred that the absorbent polymer fiber obtainable according to one of the above described processes has at least one, preferably all of the following properties:
(γ1) a part soluble in water (LA) after 16 hours of less than about 30 wt. %, preferably less than about 25 wt. % and particularly preferably less than about 20 wt. %, based on the absorbent polymer fiber, according to ERT 470.1-99,
(γ2) a part soluble in water (LA) after 1 hour of less than 30 wt. %, preferably less than about 24 wt. % and particularly preferably less than about 18.2 wt. %, based on the absorbent polymer fiber, according to ERT 470.1-99,
(γ3) a Centrifuge Retention Capacity (CRC) of at least about 5 g/g, preferably at least about 15 g/g and particularly preferably at least about 18 g/g, according to ERT 441.1-99,
(γ4) an Absorption Against Pressure (AAP) at a load of 0.3 psi of at least about 10 g/g, preferably at least about 12 g/g and particularly preferably at least about 14 g/g, according to ERT 442.1-99,
(γ5) an Absorption Against Pressure (AAP) at a load of 0.7 psi of at least about 5 g/g, preferably at least about 7 g/g and particularly preferably at least about 10 g/g, according to ERT 442.1-99.

Of the above detailed properties, each of these properties represents by itself or in any combination a property or property combination of an embodiment of the absorbent polymer fiber according to the invention. Furthermore, further embodiments of the absorbent polymer fiber according to the invention have property combinations which are characterized by means of the following figures: γ1, γ2, γ3, γ4, γ1 γ4, γ1 γ2, γ2 γ3, γ3 γ4, γ1γ3γ4, γ2γ3γ4, γ1γ2γ3, γ1γ2γ3γ4, γ1γ5, γ2γ5, γ3γ5, γ4γ4, γ1γ4γ5, γ1γ2γ5, γ2γ3γ5, γ3γ4γ5, γ1γ3γ4γ5, γ2γ3γ4γ5, γ1γ2γ3γ5, γ1γ2γ3γ4γ5, whereby γ1γ2γ3 is particularly preferred.

In a further embodiment of the polymer fiber obtainable by the process according to the invention, this has a degree of softness determined according to the herein-described test methods of at least 3, preferably of 4. It is furthermore preferred that the absorbent polymer fibers obtainable according to the process according to the invention have a length within a range of about 1 mm to about 10 m, particularly preferably within a range from about 5 mm to about 1 m and even more preferably within a range from about 10 mm to about 10 cm and yet more preferably within a range from about 20 mm to about 100 mm, whereby the average diameter of the polymer fiber is preferably within a range from about 0.1 to about 10,000 μm, particularly preferably within a range from about 1 to about 1000 μm and even more preferably within a range from about 5 to about 500 μm.

It is furthermore preferred that according to an embodiment according to the invention of the process according to the invention as well as of the absorbent polymer fiber according to the invention, the values of features according to the invention only given with a lower limit have an upper limit which is 20-fold, preferably 10-fold and particularly preferably 5-fold the most preferred value of the lower limit.

The present invention also relates to a fiber matrix sheet structure comprising at least two, preferably at least 10, particularly preferably at least 1000, even more preferably at least 10,000 and yet more preferably at least 1,000,000 of the absorbent polymer fibers obtainable by the process according to the invention. The fiber matrix sheet structure according to the invention can preferably be a laid material, a meshed material, a woven material, a knitted material, a wound material or a non-woven material.

The production of the fiber matrix sheet structure according to the invention occurs by production processes known to the skilled person for structures of these types. Preferably a production of the fiber matrix sheet structure occurs by spunbond processes, spunlace processes, airlaid processes or wetlaid processes.

The mass per unit area of the fiber matrix sheet structure according to the invention lies preferably within a range from about 1 to about 1000 g/m², particularly preferably within a range from about 5 to about 500 g/m², more preferably within a range from about 10 to about 250 g/m² and even more preferably within a range from about 20 to about 100 g/m², whereby the thickness of the fiber matrix sheet structure preferably lies within a range from about 100 μm to about 10 cm, particularly preferably within a range from about 500 μm to about 5 cm and even more preferably within a range from about 1 mm to about 10 mm.

It is furthermore preferred according to the invention that the fiber matrix sheet structure has a total grip, determined according to the test process “TAPPI 4998 CM-85” by means of a Thwing Albert Handle-O-Meters, Model 211-5 with a column width of 0.64 cm, a fiber matrix sheet structure size of 20 cm×20 cm and a mass per unit area of 70 g/m², of at most about 1000 g, particularly preferably of at most about 100 g, even more preferably of at most about 75 g, yet more preferably at most about 50 g and most preferably of at most about 25 g.

In a particular embodiment of the fiber matrix sheet structure according to the invention this can also comprise, besides the absorbent polymer fibers obtainable by the process according to the invention, further, preferably thermoplastic, polymers, which for example enable a fixing of the fibers within the fiber matrix sheet structure. Polyethylene and polypropylene in particular belong to the thermoplastic polymers, whereby these polymers can preferably be comprised in the fiber matrix sheet structure in a quantity within a range from about 0.1 to about 50 wt. %, particularly preferably within a range from about 0.1 to about 20 wt. % and even more preferably in a quantity within a range from about I to about 10 wt. %, based upon the total weight of the fiber matrix sheet structure.

The present invention furthermore relates to a composite comprising an above-defined absorbent polymer fiber or an above-defined fiber matrix sheet structure and a substrate. It is preferred that the absorbent polymer fiber according to the invention or the fiber matrix sheet structure according to the invention and the substrate are firmly combined with one another. Preferred substrates include sheets formed from polymers, for example from polyethylene, polypropylene or polyamide, metals, non-wovens, fluff, tissues, woven materials, natural or synthetic fibers, or other foams.

According to the invention preferred composites are sealant materials, cables, absorbent cores as well as diapers and hygiene articles comprising these. The sealant materials are preferably water-absorbing films, wherein the absorbent polymer fiber or the fiber matrix sheet structure is incorporated in a polymer matrix or fiber matrix as substrate. This is preferably carried out by mixing the absorbent polymer fiber or the fiber matrix sheet structure with a polymer (Pm) forming the polymer matrix or fiber matrix, and then binding, optionally by thermal treatment. Yarns of the absorbent polymer fiber may also be obtained, which are spun with further fibers of another material as a substrate, and are then combined with one another, for example by weaving or knitting, or are combined directly, i.e. without having been spun with further fibers. Typical processes for this purpose are described by H. Savano et al., International Wire & Cable Symposium Proceedings 40, 333 to 338 (1991); M. Fukuma et al., International Wire & Cable Symposium Proceedings 36, 350 to 355 (1987) and in U.S. Pat. No. 4,703,132.

In the embodiment in which the composite is a cable, the absorbent polymer fiber may be used in the form of swellable, tensile strength yams. In the case of the cable, the substrate forms all the constituents of the cable that do not contain absorbent polymer fiber. These include the conductors incorporated in the cable, such as electrical conductors or light conductors, optical and/or electrical insulating materials, as well as constituents of the cable that ensure the mechanical integrity of the cable, such as meshed, woven or knitted materials of high tensile strength materials, such as plastics and insulating materials of rubber or other materials that prevent the destruction of the outer sheathing of the cable.

If the composite is an absorbent core, the absorbent polymer fiber or the fiber matrix sheet structure is incorporated into a substrate. As substrate for cores are considered preferably fibrous materials comprising predominantly cellulose. In one embodiment of the core the absorbent polymer fiber is incorporated in an amount in the range from about 10 to about 90, preferably about 20 to about 80 and particularly preferably about 40 to about 70 wt. %, based on the core. The core may be produced for example by a so-called airlaid process or by a so-called wetlaid process, whereby a core produced according to the airlaid process is preferred. In the wetlaid process the absorbent polymer fibers are processed together with further substrate fibers and a liquid to form a non-woven. In the airlaid process the fibers of absorbent polymer structure and the substrate fibers are processed in the dry state into a non-woven material. Further details of the airlaid process are described in U.S. Pat. No. 5,916,670 as well as U.S. Pat. No. 5,866,242, and of the wetlaid process are described in U.S. Pat. No. 5,300,192.

In the wetlaid and airlaid processes, in addition to the absorbent polymer fibers and the substrate fibers, there may also be used further suitable auxiliary substances known to the person skilled in the art that contribute to the strengthening of the non-woven obtained by this process.

In the embodiment in which the composite is a diaper, the parts of the diaper that are different from the absorbent polymer fiber or the fiber matrix sheet structure according to the invention constitute the substrate of the composite. In a preferred embodiment the diaper comprises an above-described core. In this case the constituents of the diaper different from the core represent the substrate of the composite. In general a composite used as a diaper comprises a water-impermeable lower layer, a water-permeable, preferably hydrophobic upper layer, and a layer containing the absorbent polymer fiber, which is arranged between the lower layer and the upper layer. This layer containing the absorbent polymer fiber or the fiber matrix sheet structure according to the invention is preferably an above-described core. The lower layer may comprise all materials known to the person skilled in the art, whereby polyethylene or polypropylene are preferred. The upper layer may likewise contain all suitable materials known to the person skilled in the art, whereby polyesters, polyolefins, viscose and the like are preferred, which produce a layer that is sufficiently porous so as to ensure a satisfactory flow of liquid through the upper layer. In this connection reference is made to the disclosures in U.S. Pat. No. 5,061,295, U.S. Re. 26,151, U.S. Pat. No. 3,592,194, U.S. Pat. No. 3,489,148 as well as U.S. Pat. No. 3,860,003.

The invention further relates to a process for producing a composite, whereby an absorbent polymer fiber according to the invention or a fiber matrix sheet structure according to the invention and a substrate and optionally a suitable additive are brought into contact with each other. The bringing into contact preferably occurs by wetlaid and airlaid processes, compacting, extruding and mixing.

The invention additionally relates to a composite that is obtainable by the above process.

The invention further relates to foams, formed bodies, fibers, sheets, films, cables, sealant materials, liquid-absorbing hygiene articles, carriers for plant and fungus growth regulating agents, additives for construction materials, packaging materials and soil additives, which comprise the polymer fiber according to the invention, the fiber matrix sheet structure or the above-described composite. In particular, the present invention relates to a hygiene article, preferably a diaper or a sanitary napkin, comprising the above-described fiber matrix sheet structure, whereby the fiber matrix sheet structure is comprised in the hygiene article in an amount within a range from about 10 to about 99 wt. %, particularly preferably within a range from about 60 to about 98 wt. % and even more preferably in an amount within a range from about 70 to about 95 wt. %, respectively based upon the total weight of the hygiene article.

In addition, the invention relates to the use of the absorbent polymer fibers according to the invention, of the fiber matrix sheet structure according to the invention or of the above-described core in foams, formed bodies, fibers, sheets, films, cables, sealant materials, liquid-absorbing hygiene articles, carriers for plant and fungus growth regulating agents, additives for construction materials, packaging materials, for controlled release of active substances or in soil additives.

The invention is now described by means of non-limiting figures and examples.

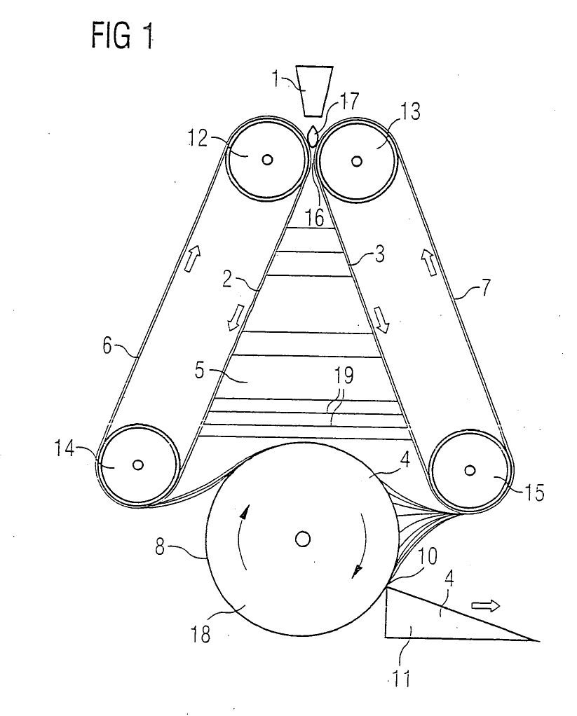

FIG. 1 shows a cross-section sketch of a device preferred according to the invention for producing absorbent polymer fibers.

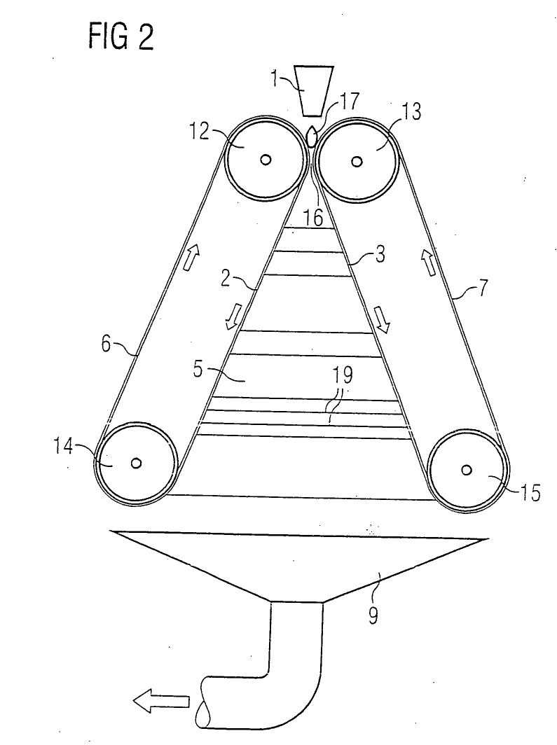

FIG. 2 shows a further cross-section sketch of another embodiment of the device according to the invention for producing absorbent polymer fibers.

In FIG. 1, the polymer feed 1 is arranged before a gap 16 formed by both surfaces of the belts 6 and 7 in the region of the start rolls 13 and 14 of these belts. The polymer feed 1 releases a polymer portion 17 that arrives at the gap 16. The movable surfaces 2 and 3 are formed by roll belts with belts 6 and 7, whereby the belts 6 and 7 are arranged over start rolls 12 and 13 and end rolls 14 and 15 as closed belts. The belts 6 and 7 move over the rolls in the directions indicated with arrows. The gap formed in the area of the start rolls 12 and 13 by the surfaces 2 and 3 is designed such that the polymer portion 17 comes into contact with the surfaces 2 and 3. Preferably the start rolls 12 and 13 are in the form of rollers. According to an embodiment of the device according to the invention, these rollers can comprise recesses that are preferably designed elongated, in order to form a polymer portion which can be pulled into fibers of absorbent polymer. The distance between the end rolls 14 and 15 is larger than the distance between the start rolls 12 and 13. The substantially triangular area formed by the movable surface 2 between the start roll 12 and the end roll 14 and the movable surface 3 between the start roll 13 and the end roll 15 as well as the distance between the end roll 14 and the end roll 15, is the fiber formation area 5. In the fiber formation area 5, an irradiation device (not shown) can be arranged, which is, for example, a heater. Adjacent to the end rolls 14 and 15 is arranged the fiber-accepting device 4. The fiber-accepting device 4 comprises a collecting surface 8 that is preferably on a rotating drum 18. The drum 18 is preferably formed dumbbell-shaped with different circular diameters, whereby the area of the dumbbell with the smaller circular diameter is somewhat smaller than the width of the surface along the axis of the end rolls 14 and 15, in order to compact the absorbent polymer fiber 19 taken up by the fiber-accepting device 4 via the collecting surface 8. Furthermore, the fiber-collecting device 4 comprises a take up device 11 comprising an edge 10, whereby the edge 10 is so close to the collecting surface 8 that a film of absorbent polymer fibers 19 forming upon the collecting surface 8 is taken off by the edge 10. These absorbent polymer fibers 19 are then conducted to further processing, for example a further spinning to produce a yarn of absorbent polymer fibers.

FIG. 2 corresponds to FIG. 1, with the difference that as fiber-accepting device, here a suction device 9 is arranged adjacent to the end rolls 14 and 15, by means of which the absorbent polymer fibers 19 are separated from the movable surfaces 2 and 3 of the belts 6 and 7. The suction device 9 is preferably funnel-shaped, so that the accepted absorbent polymer fibers 19 can be compacted. The thus-obtained absorbent polymer fibers 19 can, following the suction device 9, be conducted to a further processing, for example the production of a non-woven by means of an airlaid device.

Test Methods

All tests given herein as ERT methods correspond to the test methods recommended by EDANA (European Diaper And Non-woven Association).

Determination of the Degree of Softness of an Absorbent Polymer Fiber

The determination of the degree of softness of an absorbent polymer is carried out in that ten different test persons investigate the feel of a polymer fiber by means of a feel impression obtained with the fingers, whereby the softness of the absorbent polymer fiber is arranged into the following four degrees of softness:

Softness degree 4: feather-like feel, which was very soft, flexible and supple

Softness degree 3: a soft, flexible and supple feel

Softness degree 2: the feel is rough and hard with some impairment of the softness, flexibility and suppleness

Softness degree 1: the feel is rough and hard with poor softness, flexibility and suppleness.

### EXAMPLES

Production of the Polymer (A1)

### Example 1

1,299.60 g NaOH (50%) and 5,251.00 g water were placed in a 15 L flask with a ground glass neck. 2,342.40 g acrylic acid was introduced with stirring at a temperature of 50° C. After one hour's inerting with nitrogen, the polymerization is started by addition of the following solutions in the given order at a temperature of 25° C.:
1) 1.26 g mercaptoethanol;
2) 9.00 g ABAH (2,2′-azobis(2-amidinopropan)dihydrochloride), dissolved in 60 g water;
3) 1.20 g ascorbic acid, dissolved in 30 g water;
4) 4.50 g H₂O₂ (30%).

After reaching the maximum temperature of 100.4° C. after 6.5 minutes, starring was continued for 1 hour at this temperature. The thus-obtained Na polyacrylate was concentrated by further evaporation in a rotary evaporator to a polymer content (WS) of 50%.

### Example 2

1,299.60 g NaOH (50%) and 5,252.04 g water were placed in a 15 L flask with a ground glass neck. 2,342.40 g acrylic acid was introduced with stirring at a temperature of 50° C. After inerting for one hour with nitrogen, the polymerization was started by addition of the following solutions in the given order at a temperature of 25° C.:
1) 1.26 g mercaptoethanol;
2) 9 g ABAH (2,2′-azobis(2-amidinopropan)dihydrochloride), dissolved in 60 g water;
3) 1.2 g ascorbic acid, dissolved in 30 g water;
4) 4.5 g H₂O₂ (30%).

After reaching the maximum temperature of 100.2° C. after 3.5 minutes, stirring was continued for 1 hour at this temperature. The thus-obtained Na polyacrylate was concentrated by further evaporation in the rotary evaporator to a WS of 50%.

The polymers (A1) or compositions obtained in examples 1 and 2 are characterized by the following properties:

| Property | Example 1 | Example 2 |
|---|---|---|
| Polydispersity | 5.5 | 8.0 |
| Viscosity at 23° C. | 21,750 | 65,600 |
| [mPa · s] in 30 wt. % solution | | |
| Viscosity at 60° C. | 2,890 | 9,460 |
| [mPa · s] in 30 wt. % solution | | |
| Weight average of the molecular | 220,000 | 290,000 |
| weight [g/mol] | | |
| Residual monomer content [ppm] | 1,700 | 1,400 |

Crosslinker Addition

To an aqueous solution of the previously produced polyacrylic acid, was added crosslinker with vigorous stirring and heating of the aqueous solution to at most 30° C. The liquid crosslinkers were used as such, the crystalline pentaerythritol was added as a 6% aqueous solution. In order to guarantee a homogeneous distribution of the crosslinker in the aqueous polyacrylic acid solution, the crosslinker or the aqueous crosslinker solution respectively was coloured with methylene blue.

Fiber Production

In the fiber production, the aqueous solution comprising the crosslinker and polyacrylic acid was placed on the flat reverse side of a Petri dish. A further Petri dish was, likewise with its reverse side, pressed onto the polymer, so that the polymer formed a film between the two Petri dishes. Both Petri dishes were then slowly pulled away from each other until threads with a length of approximately 40 cm were produced. The thus-formed threads were taken up by a drum with a diameter of 19 cm and a length of 20 cm, rotating with approximately 80 revolutions per minute, whose surface was provided with paper coated with silicone (company B.Laufenberg, Krefeld, “Transferpapier NSA 1350 (56 B3)” with dimensions 40 cm×250 m. The threads were collected for as long as they pulled off the surface of the Petri dishes. After a sufficient amount has formed on the silicone-coated paper, the silicone-coated paper was taken from the drum and dried in a circulating air drying cupboard. The dried threads were separated from the roll-shaped paper coated with silicone by cutting the fibers lengthwise and removed from the silicone-coated surface. In this way, a non-woven, formed from many individual fibers, with textile feel and excellent swelling properties was obtained. The reaction conditions and the measured properties of the thus-obtained absorbent polymer fibers are collected in the table.

TABLE

| | Polymer | | Mw | | Crosslinker/ | Drying | | | | |
|---|---|---|---|---|---|---|---|---|---|---|
| | in water | | [1000 | Cross- | polymer | Temp | Duration | | LA 1 h | LA 16 h |
| No. | [wt. %] | DN | g/mol] | linker | [wt. %] | [° C.] | [min.] | CRC | [wt. %] | [wt. %] |
| 1 | 50 | 50 | 290 | A | 2 | 180 | 5 | 21.9 | 14.0 | 19.0 |
| 2 | 55.6 | 50 | 220 | A | 1.8 | 180 | 5 | 18.9 | 15.1 | 19.7 |
| 3 | 50 | 50 | 290 | A | 1.5 | 180 | 5 | 23.8 | 44.0 | 38.0 |
| 4 | 50 | 50 | 290 | B | 4 | 180 | 5 | 23.6 | 20.5 | 22.1 |
| 5 | 50 | 50 | 290 | C* | 2 | 190 | 4 | 21.1 | 11.2 | 17.8 |
| 6 | 50.6 | 50 | 220 | C* | 2 | 190 | 4 | 18.1 | 9.0 | 10.9 |

| | | |
|---|---|---|
| 7 | Oasis fiber from Acordis (comparison) | 24.0 |

DN = degree of neutralization
A = 1,4-butandiol
B = 1,3-Propandiol
C = Pentaerythritol
* = as 6 wt. % aqueous solution

### LIST OF REFERENCE CHARACTERS

1 polymer feed
2 movable surface
3 movable surface
4 fiber-accepting device
5 fiber formation area
6 belt
7 belt
8 collecting surface
9 suction device
10 edge
11 take up device
12 start roll
13 start roll
14 end roll
15 end roll
16 gap
17 polymer portion
18 drum
19 absorbent polymer fibers

1. A process for producing an aqueous phase- or water-absorbing polymer fiber from a composition comprising a polymer (A1) and water in an amount of at least about 10 wt. %, based on the total weight of the polymer (A1), wherein at least two different regions of the polymers (A1) are moved away from each other by free pulling apart as a result of the effect of an external force.

2. The process according to claim 1, wherein through the pulling apart of the polymer (A1) an elongated structure is formed.

3. The process according to claim 2, wherein the pulling apart occurs in a housing which is not form-locked for the elongated structure.

4. The process according to any one of the preceding claims claim 1, wherein the external force is at least about 0.1 N.

5. The process according to claim 1, wherein the polymer (A1) is post-crosslinked during or after the pulling apart.

6. The process according to claim 5, wherein the post-crosslinking occurs by irradiation.

7. The process according to claim 1, wherein the polymer (A1) is based, besides water, on:
(α1) about 0.1 to about 99.999 wt. % of polymerized, ethylenically unsaturated, acid groups-containing monomers or salts thereof or polymerized, ethylenically unsaturated monomers comprising a protonated or quaternated nitrogen, or mixtures thereof,
(α2) 0 to about 70 wt. % of polymerized, ethylenically unsaturated monomers co-polymerizable with (α1),
(α3) 0 to about 30 wt. % of one or more crosslinkers,
(α4) 0 to about 30 wt. % of water-soluble polymers, and
(α5) 0 to about 20 wt. % of one or more additives, wherein the sum of the weight quantities (α1) to (α5) amounts to 100 wt. %.

8. The process according to claim 1, wherein the polymer (A1) has at least one of the following properties:
a. a polydispersity D of at most about 8,
b. a viscosity in a 30 wt. % polymer-containing aqueous solution at 23° C. within a range from about 100 to about 500000 mPa.s,
c. a viscosity in a 30 wt. % polymer-containing aqueous solution at 60° C. within a range from about 100 to about 100000 mPa.s,
d. a weight average of the molecular weight (M_{W}) within the range from about 50000 to about 2,000,000 g/mol.

9. A device comprising:
(β1) a polymer feeds,
(β2) at least two movable surfaces,
(β3) a fiber-accepting device,
(β4) a fiber formation area, and
(β5) an irradiation device arranged in the fiber formation area, wherein the movable surfaces are arranged moving away from the polymer feed and with an increasing distance to each other from the polymer feed, forming the fiber formation area and the fiber-accepting device is arranged at least partially in or outside the fiber formation area.

10. The device according to claim 9, wherein the movable surfaces are as belts.

11. The device according to claim 9, wherein the fiber-accenting device is a movable collecting surface or a suction device.

12. The device according to claim 11, wherein adjacent to the collecting surface a take up device comprising an edge is arranged.

13. The device according to claim 9, wherein an irradiating device is arranged at least partially in the fiber formation area or adjacent to the collecting surface or to the take up device or at least two thereof.

14. The process according to claim 1, wherein the production of the absorbent polymer fiber occurs by means of a device defined in claim 9.

15. An absorbent polymer fiber obtainable according to a process according to claim 1.

16. An absorbent polymer fiber according to claim 15 with at least one of the following properties:
(γ1) a part soluble in water after 16 hours of less than 30 wt. %, based on the absorbent polymer fiber, according to ERT 470.1-99,
(γ2) a part soluble in water after 1 hour of less than 30 wt. %, based on the absorbent polymer fiber, according to ERT 470.1-99,
(γ3) a Centrifuge Retention Capacity (CRC) of at least about 5 g/g, according to ERT 441.1-99,
(γ4) an Absorption Against Pressure (AAP) at a load of 0.3 psi of at least about 10 g/g according to ERT 442.1-99,
(γ5) an Absorption Against Pressure (AAP) at a load of 0.7 psi of at least about 5 g/g according to ERT 442.1-99.

17. A fiber matrix sheet structure comprising at least two of the absorbent polymers according to claim 15.

18. A fiber matrix sheet structure according to claim 17, wherein the sheet structure is a laid material, a mesh, a woven material, a knitted material, a wound material or a non-woven material.

19. A composite comprising an absorbent polymer fiber according to claim 15 or a fiber matrix sheet structure according to claim 17.

20. Use of a device according to claim 9 for the production of absorbent polymer fibers.

21. A chemical product comprising an absorbent polymer fiber according to claim 15, a fiber matrix sheet structure according to claim 17 or a composite according to claim 19.

22. A chemical product comprising an absorbent polymer fiber according to claim 15, a fiber matrix sheet structure according to claim 17 or a composite according to claim 19.
